(19) United States
(12) Patent Application Publication
(10) Pub. No.: US 2024/0317321 A1
(43) Pub. Date: Sep. 26, 2024

(54) VEHICLE BODY REAR STRUCTURE

(71) Applicant: Honda Motor Co., Ltd., Tokyo (JP)

(72) Inventors: Nozomi MIKAMI, Tokyo (JP); Shungo CHINO, Tokyo (JP)

(73) Assignee: Honda Motor Co., Ltd., Tokyo (JP)

(21) Appl. No.: 18/586,518

(22) Filed: Feb. 25, 2024

(30) Foreign Application Priority Data
Mar. 23, 2023 (CN) 202310291255.7

(51) Int. Cl. B62D 25/20

(52) U.S. Cl. CPC B62D 25/2027; B62D 25/2036

(57) ABSTRACT

A vehicle body rear structure, disposed in a vehicle, includes: a floor panel; a side sill, disposed on an outer side of the floor panel in a width direction of the vehicle and extending along a front-rear direction of the vehicle; and a rear side frame, connected to a rear portion of the side sill and extending at a rear portion of the vehicle along the front-rear direction of the vehicle. The rear side frame includes: a rear side frame upper located above the vehicle; and a rear side frame lower located below the vehicle. The side sill includes: a first joint portion, connected to the rear side frame lower; and a second joint portion, connected to the rear side frame upper. The first joint portion and the second joint portion are juxtaposed in the width direction of the vehicle and extend in the front-rear direction of the vehicle.

### CROSS-REFERENCE TO RELATED APPLICATION

This application claims the priority benefit of China application serial no. 202310291255.7, filed on Mar. 23, 2023. The entirety of the above-mentioned patent application is hereby incorporated by reference herein and made a part of this specification.

### BACKGROUND

### Technical Field

The disclosure relates to a vehicle body rear structure.

### Description of Related Art

In recent years, efforts have been made to provide sustainable transportation systems taking into account disadvantaged groups among transportation participants, such as the elderly, the disabled, and children. In order to achieve this, efforts are being made to develop technologies to improve vehicle body rigidity to further improve transportation safety and convenience.

In Patent Literature 1 (Japanese Patent Application Laid-Open No. H04-71968), a rear side frame outer extends between a side sill outer and a side sill inner to increase the joint rigidity between a side sill and a rear side frame.

However, in Patent Literature 1, in addition to the weight increase due to the extension of the rear side frame, in recent years, the weight of the vehicle has increased due to the installation of a large battery, and it is needed to consider further improving the joint rigidity.

The disclosure provides a vehicle body rear structure, which is capable of improving the joint rigidity between the side sill and the rear side frame with a simple structure.

### SUMMARY

The vehicle body rear structure according to the disclosure is disposed in a vehicle. The vehicle body rear structure includes: a floor panel; a side sill, which is disposed on an outer side of the floor panel in a width direction of the vehicle and extends along a front-rear direction of the vehicle; and a rear side frame, which is connected to a rear portion of the side frame and extends along the front-rear direction of the vehicle at a rear portion of the vehicle. The rear side frame includes: a rear side frame upper located above the vehicle; and a rear side frame lower located below the vehicle. The side sill includes: a first joint portion, which is connected to the rear side frame lower; and a second joint portion, which is connected to the rear side frame upper. The first joint portion and the second joint portion are juxtaposed in the width direction of the vehicle and extend in the front-rear direction of the vehicle.

In this way, by forming two rows of the joint portions between the side sill and the rear side frame lower/the rear side frame upper, the load between the side sill and the rear side frame may be dispersed by the two rows of the joint portions, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

In order to make the above-mentioned features and advantages of the disclosure comprehensible, embodiments accompanied with drawings are described in detail as follows.

### BRIEF DESCRIPTION OF THE DRAWINGS

FIG. 1 is a schematic plan view of a vehicle body rear structure disposed in a vehicle according to an embodiment of the disclosure.

FIG. 2 is a schematic bottom view of a vehicle body rear structure disposed in a vehicle according to an embodiment of the disclosure.

FIG. 3 is a schematic perspective view of a vehicle body rear structure disposed in a vehicle according to an embodiment of the disclosure.

FIG. 4 is a schematic diagram of a vehicle body rear structure disposed in a vehicle according to another embodiment of the disclosure.

FIG. 5 is a schematic diagram of the vehicle body rear structure of FIG. 4 viewed from another angle, in which merely the rear side frame lower of the rear side frame is shown.

FIG. 6 is a schematic diagram of the vehicle body rear structure of FIG. 4 viewed from another angle, in which the rear side frame lower and the rear side frame upper of the rear side frame are shown.

FIG. 7 is a schematic diagram of a vehicle body rear structure disposed in a vehicle according to yet another embodiment of the disclosure.

FIG. 8 is a schematic diagram of a vehicle body rear structure disposed in a vehicle according to another embodiment of the disclosure.

FIG. 9 is a schematic view of the extension member of the vehicle body rear structure of FIG. 8.

FIG. 10 is a schematic diagram of the vehicle body rear structure of FIG. 8 viewed from another angle.

### DESCRIPTION OF THE EMBODIMENTS

In an embodiment of the disclosure, the rear side frame lower includes a side wall which opens upward and a bottom wall connected to the side wall. The first joint portion is disposed along an inner end portion of the side sill in the width direction of the vehicle, and a joint flange of the side wall is joined to the side sill.

In this way, by joining the U-shaped rear side frame lower along the inner end portion of the side sill, the load in the front-rear direction of the vehicle may be effectively transmitted to the side sill, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

In an embodiment of the disclosure, the rear side frame upper extends from the rear side frame lower toward an outer side in the width direction of the vehicle. The second joint portion is disposed on an outer side of the first joint portion in the width direction of the vehicle.

In this way, the rear side frame upper and the second joint portion of the side sill are disposed on the outer side of the first joint portion, and the joint portions (that is, the first joint portion and the second joint portion) are arranged in two rows. The load between the side sill and the rear side frame may be dispersed by the two rows of the joint portions, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

In an embodiment of the disclosure, the side sill includes an extension member, which extends along the front-rear direction of the vehicle within a cross section of the side sill. The rear side frame lower and the rear side frame upper are connected to the extension member.

In this way, by joining the rear side frame lower and the rear side frame upper to the extension member, the load between the side sill and the rear side frame may be dispersed by two rows of the joint portions (that is, the first joint portion and the second joint portion), thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

In an embodiment of the disclosure, the vehicle body rear structure further includes a floor cross member, which is disposed in front of the rear side frame and connected to the side sill. The side sill includes an inner side sill, which is disposed on an inner side of the side sill in the width direction of the vehicle. The extension member is disposed on the inner side sill. The extension member extends from the rear side frame to the floor cross member.

In this way, by extending the extension member from the rear side frame to the floor cross member, the load input to the rear side frame may be transmitted to the floor cross member via the extension member, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

In an embodiment of the disclosure, the extension member includes: an inner wall, which is located on an inner side in the width direction of the vehicle; and an upper wall, which extends from an upper portion of the inner wall toward the outer side in the width direction of the vehicle. The upper wall has multiple bead portions, and the length direction of the bead portion is the width direction of the vehicle. The rear side frame lower and the rear side frame upper are connected to the bead portions.

In this way, by connecting the rear side frame lower and the rear side frame upper to the bead portions, the load may be transmitted to the bead portions of high rigidity, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed. In addition, the upper wall of the extension member may withstand a load from the side (that is, in the width direction of the vehicle) because of having the bead portions.

In an embodiment of the disclosure, the vehicle body rear structure further includes a wheel house, which is disposed above the rear side frame upper. The rear side frame upper includes a longitudinal flange, which is disposed behind the second joint portion and extends toward above the vehicle. The longitudinal flange has a third joint portion, which is connected to the wheel house and the side sill along the front-rear direction of the vehicle.

In this way, by connecting the longitudinal flange of the rear side frame upper to the wheel house and the side sill in the front-rear direction of the vehicle, the load input in the front-rear direction of the vehicle may be effectively transmitted, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

In an embodiment of the disclosure, the rear side frame upper and the rear side frame lower are joined together with the floor panel sandwiched therebetween on the inner side in the width direction of the vehicle.

In this way, by joining the rear side frame upper and the rear side frame lower with the floor panel sandwiched therebetween on the inner side in the width direction of the vehicle, the rigidity of the rear side frame may be improved, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

In an embodiment of the disclosure, the rear side frame and the floor cross member are spaced apart in the front-rear direction of the vehicle.

In this way, by spacing the rear side frame and the floor cross member in the front-rear direction of the vehicle, the degree of layout freedom in the vicinity of the rear side frame and the side sill may be increased, and such a design may be applied to vehicle types with the rear side frame of different overall lengths (In conventional technology, the rear side frame is connected to the floor cross member to bear the load in the front-rear direction of the vehicle. In this case, the length of the rear side frame and the connection to the floor cross member have to be specially designed and cannot be applied).

The vehicle body rear structure of the disclosure has at least the following technical effects.

By forming two rows of the joint portions between the side sill and the rear side frame lower/the rear side frame upper, the load between the side sill and the rear side frame may be dispersed by the two rows of the joint portions, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By joining the U-shaped rear side frame lower along the inner end portion of the side sill, the load in the front-rear direction of the vehicle may be effectively transmitted to the side sill, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

The rear side frame upper and the second joint portion of the side sill are disposed on the outer side of the first joint portion, and the joint portions (that is, the first joint portion and the second joint portion) are arranged in two rows. The load between the side sill and the rear side frame may be dispersed by the two rows of the joint portions, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By joining the rear side frame lower and the rear side frame upper to the extension member, the load between the side sill and the rear side frame may be dispersed by two rows of the joint portions (that is, the first joint portion and the second joint portion), thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By extending the extension member from the rear side frame to the floor cross member, the load input to the rear side frame may be transmitted to the floor cross member via the extension member, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By connecting the rear side frame lower and the rear side frame upper to the bead portions, the load may be transmitted to the bead portions of high rigidity, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed. In addition, the upper wall of the extension member may withstand a load from the side (that is, in the width direction of the vehicle) because of having the bead portions.

By connecting the longitudinal flange of the rear side frame upper to the wheel house and the side sill in the front-rear direction of the vehicle, the load input in the front-rear direction of the vehicle may be effectively transmitted, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By joining the rear side frame upper and the rear side frame lower with the floor panel sandwiched therebetween on the inner side in the width direction of the vehicle, the rigidity of the rear side frame may be improved, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By spacing the rear side frame and the floor cross member in the front-rear direction of the vehicle, the degree of layout freedom in the vicinity of the rear side frame and the side sill may be increased, and such a design may be applied to vehicle types with the rear side frame of different overall lengths (In conventional technology, the rear side frame is connected to the floor cross member to bear the load in the front-rear direction of the vehicle. In this case, the length of the rear side frame and the connection to the floor cross member have to be specially designed and cannot be applied).

Hereinafter, embodiments of the disclosure will be described based on the drawings. It should be noted that in each of the embodiments described below, the same reference numerals are assigned to common parts, and repeated descriptions will be omitted. Hereinafter, embodiments of the disclosure will be described with reference to the drawings.

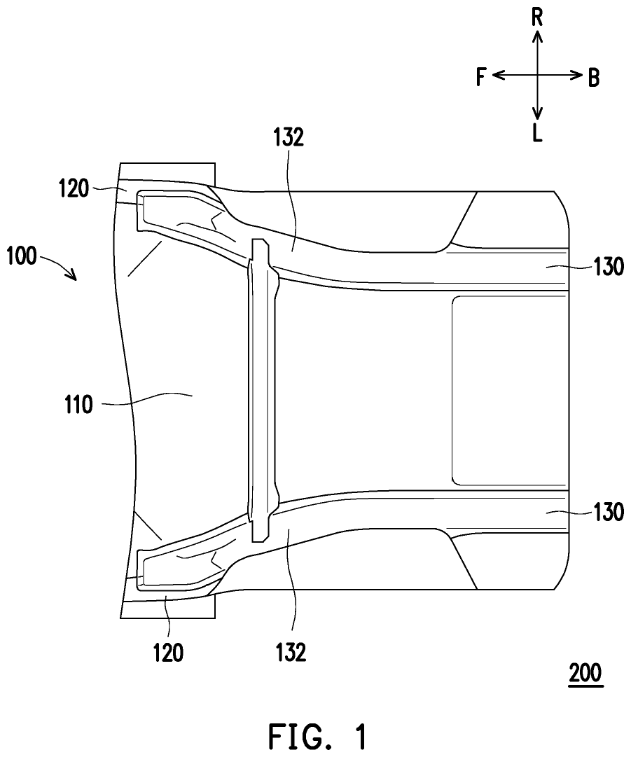

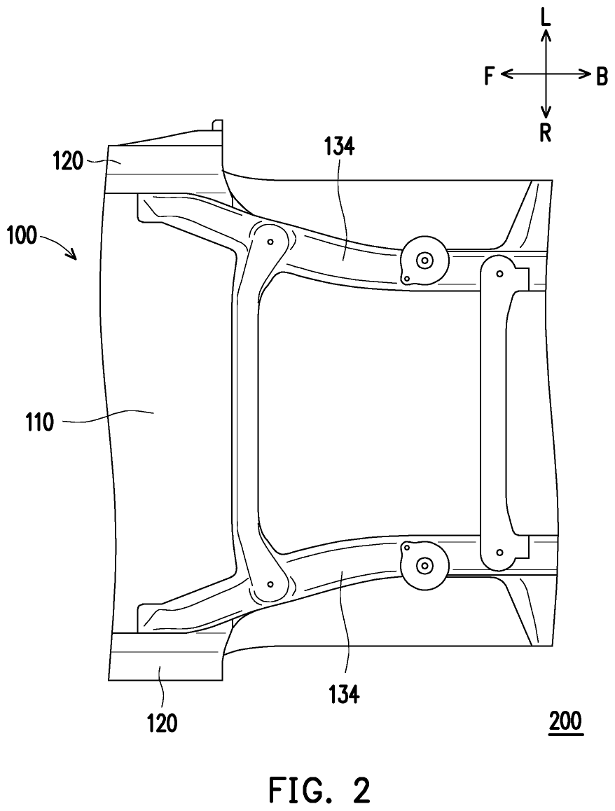

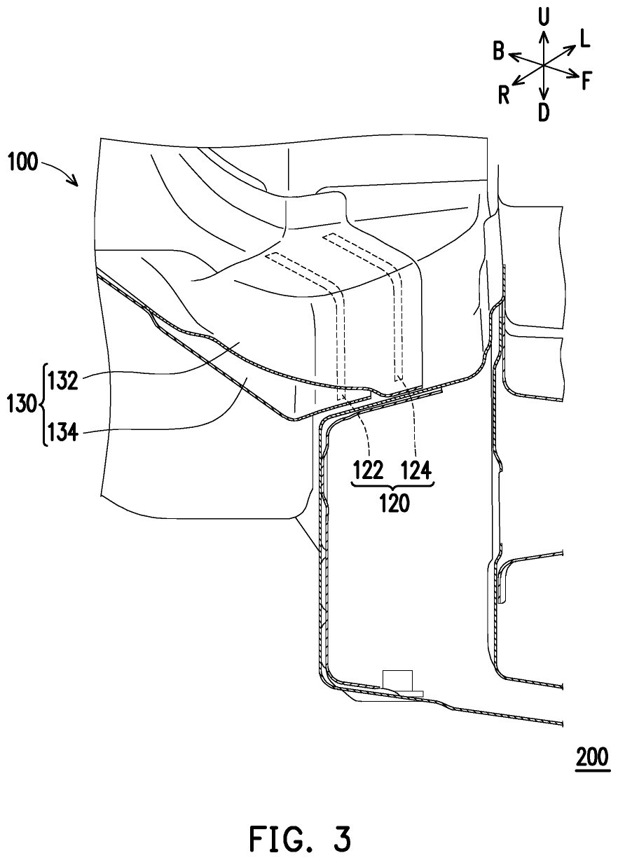

FIG. 1 is a schematic plan view of a vehicle body rear structure disposed in a vehicle according to an embodiment of the disclosure. FIG. 2 is a schematic bottom view of a vehicle body rear structure disposed in a vehicle according to an embodiment of the disclosure. FIG. 3 is a schematic perspective view of a vehicle body rear structure disposed in a vehicle according to an embodiment of the disclosure. In FIGS. 1 to 3, the coordinate system of front F, rear B, left L, right R, above U and below D of a vehicle 200 is indicated.

Please refer to FIGS. 1 to 3 at the same time. A vehicle body rear structure 100 is disposed in the vehicle 200. The vehicle body rear structure 100 includes: a floor panel 110; a side sill 120, which is disposed on an outer side of the floor panel 110 in a width direction L-R of the vehicle 200 and extends along a front-rear direction F-B of the vehicle 200; and a rear side frame 130, which is connected to a rear portion of the side sill 120 and extends along the front-rear direction F-B of the vehicle 200 at a rear portion of the vehicle 200. The rear side frame 130 includes: a rear side frame upper 132 (as shown in FIGS. 1 and 3) located above U the vehicle 200; and a rear side frame lower 134 (as shown in FIGS. 2 and 3) located below D the vehicle 200. As shown in FIG. 3, the side sill 120 includes: a first joint portion 122, which is connected to the rear side frame lower 134; and a second joint portion 124, which is connected to the rear side frame upper 132. The first joint portion 122 and the second joint portion 124 are juxtaposed in the width direction L-R of the vehicle 200 and extend in the front-rear direction F-B of the vehicle 200.

The connection between the first joint portion 122 and the rear side frame lower 134 and the connection between the second joint portion 124 and the rear side frame upper 132 may be performed by spot welding or laser welding.

In this way, by forming two rows of joint portions 122 and 124 between the side sill 120 and the rear side frame lower 134/the rear side frame upper 132, the two rows of the joint portions 122 and 124 can disperse the load between the side sill 120 and the rear side frame 130, thereby improving the joint rigidity. Therefore, even without adding reinforcing members such as cross members in the vicinity of the first joint portion 122 and the second joint portion 124 of the side sill 120 and the rear side frame 130, breakage that occurs when a collision load is applied in the front-rear direction F-B of the vehicle 200 can be suppressed.

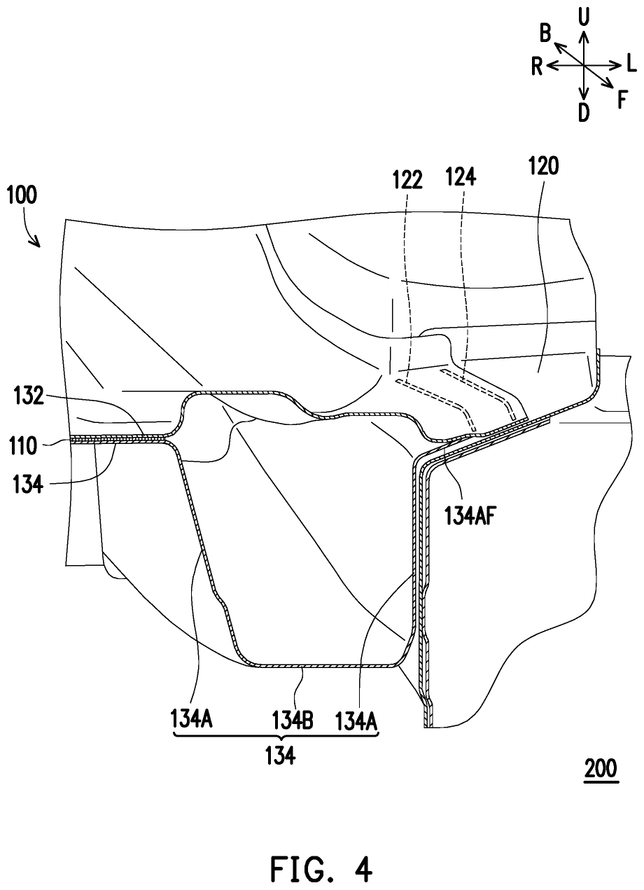

FIG. 4 is a schematic diagram of a vehicle body rear structure disposed in a vehicle according to another embodiment of the disclosure. Referring to FIG. 4, the rear side frame lower 134 includes a side wall 134A which opens upward and a bottom wall 134B connected to the side wall 134A. The first joint portion 122 is disposed along an inner end portion of the side sill 120 in the width direction L-R of the vehicle 200, and a joint flange 134AF of the side wall 134A is joined to the side sill 120.

In this way, by joining the U-shaped rear side frame lower 134 along the inner end portion of the side sill 120, the load in the front-rear direction F-B of the vehicle 200 may be effectively transmitted to the side sill 120, thereby improving the joint rigidity. Therefore, even without adding reinforcing members such as cross members in the vicinity of the first joint portion 122 and the second joint portion 124 of the side sill 120 and the rear side frame 130, breakage that occurs when a collision load is applied in the front-rear direction F-B of the vehicle 200 can be suppressed.

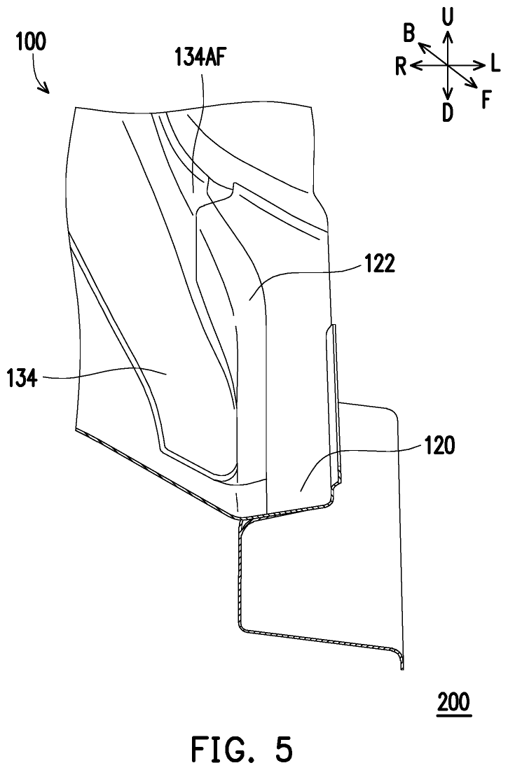

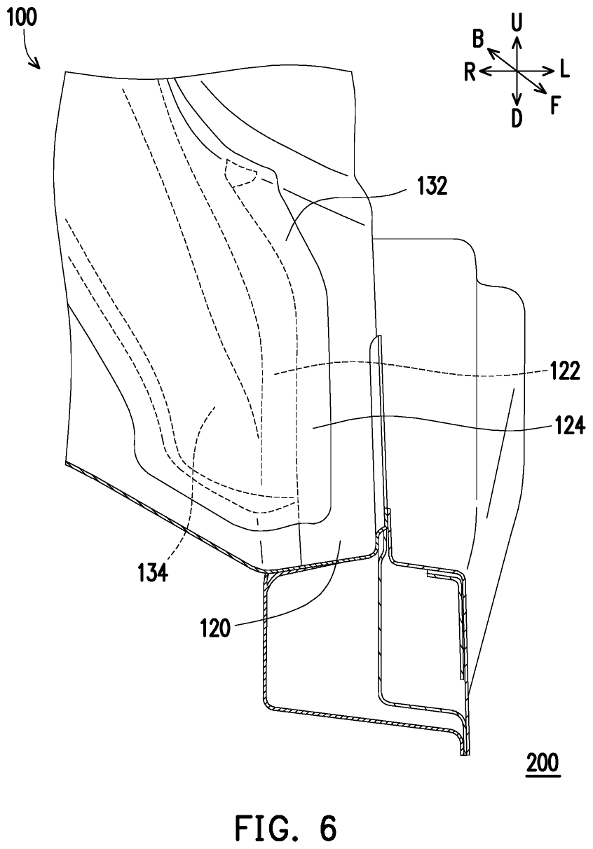

FIG. 5 is a schematic diagram of the vehicle body rear structure of FIG. 4 viewed from another angle, in which merely the rear side frame lower 134 of the rear side frame 130 is shown. FIG. 6 is a schematic diagram of the vehicle body rear structure of FIG. 4 viewed from another angle, in which the rear side frame lower 134 and the rear side frame upper 132 of the rear side frame 130 are shown. Please refer to FIGS. 5 and 6 at the same time. The rear side frame upper 132 extends from the rear side frame lower 134 toward the outer side in the width direction L-R of the vehicle 200. The second joint portion 124 is disposed on an outer side of the first joint portion 122 in the width direction L-R of the vehicle 200.

Referring to FIG. 5, the first joint portion 122 extends along an inner edge of the side sill 120 so that the rear side frame 130 is connected to the side sill 120 at the position of the first joint portion 122.

In this way, as shown in FIG. 6, the rear side frame upper 132 and the second joint portion 124 of the side sill 120 is disposed on the outer side of the first joint portion 122, and the joint portions (that is, the first joint portion 122 and the second joint portion 124) are arranged in two rows. The load between the side sill 120 and the rear side frame 130 may be dispersed by the two rows of the joint portions 122 and 124, thereby improving the joint rigidity. Therefore, even without adding reinforcing members such as cross members in the vicinity of the first joint portion 122 and the second joint portion 124 of the side sill 120 and the rear side frame 130, breakage that occurs when a collision load is applied in the front-rear direction F-B of the vehicle 200 can be suppressed.

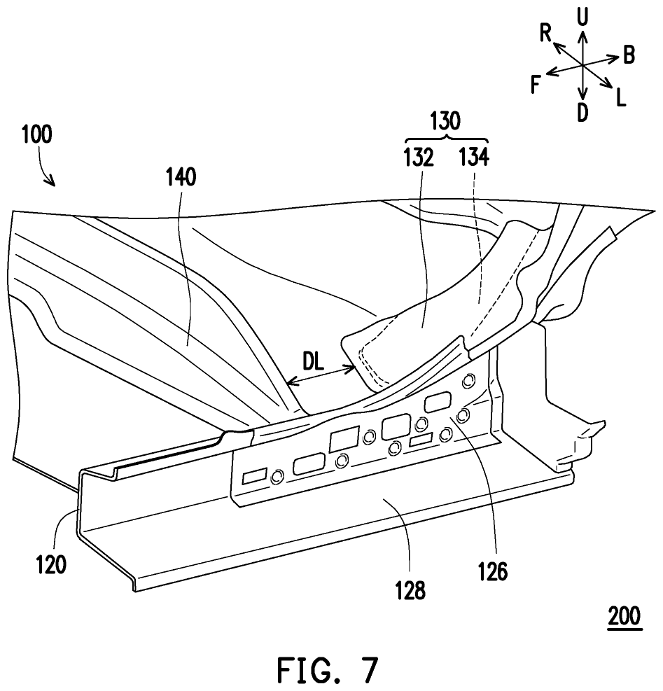

FIG. 7 is a schematic diagram of a vehicle body rear structure disposed in a vehicle according to yet another embodiment of the disclosure. Referring to FIG. 7, the side sill 120 includes an extension member 126, which extends along the front-rear direction F-B of the vehicle 200 within a cross section of the side sill 120. The rear side frame lower 134 and the rear side frame upper 132 are connected to the extension member 126.

In this way, by joining the rear side frame lower 134 and the rear side frame upper 132 to the extension member 126, the load between the side sill 120 and the rear side frame 130 may be dispersed by two rows of the joint portions (that is, the first joint portion 122 and the second joint portion 124), thereby improving the joint rigidity. Therefore, even without adding reinforcing members such as cross members in the vicinity of the first joint portion 122 and the second joint portion 124 of the side sill 120 and the rear side frame 130, breakage that occurs when a collision load is applied in the front-rear direction F-B of the vehicle 200 can be suppressed.

Please continue to refer to FIG. 7. The vehicle body rear structure 100 further includes a floor cross member 140, which is disposed in front F of the rear side frame 130 and connected to the side sill 120. The side sill 120 includes an inner side sill 128, which is disposed on the inner side of the side sill 120 in the width direction L-R of the vehicle 200. The extension member 126 is disposed on the inner side sill 128. The extension member 126 extends from the rear side frame 130 to the floor cross member 140.

In this way, by extending the extension member 126 from the rear side frame 130 to the floor cross member 140, the load input to the rear side frame 130 may be transmitted to the floor cross member 140 via the extension member 126, thereby improving the joint rigidity. Therefore, even without adding reinforcing members such as cross members in the vicinity of the first joint portion 122 and the second joint portion 124 of the side sill 120 and the rear side frame 130, breakage that occurs when a collision load is applied in the front-rear direction F-B of the vehicle 200 can be suppressed.

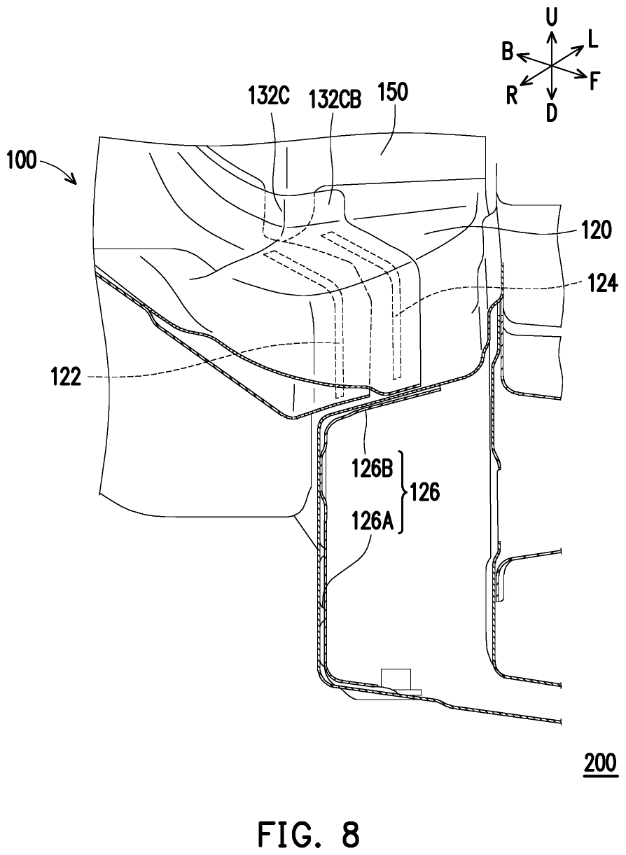

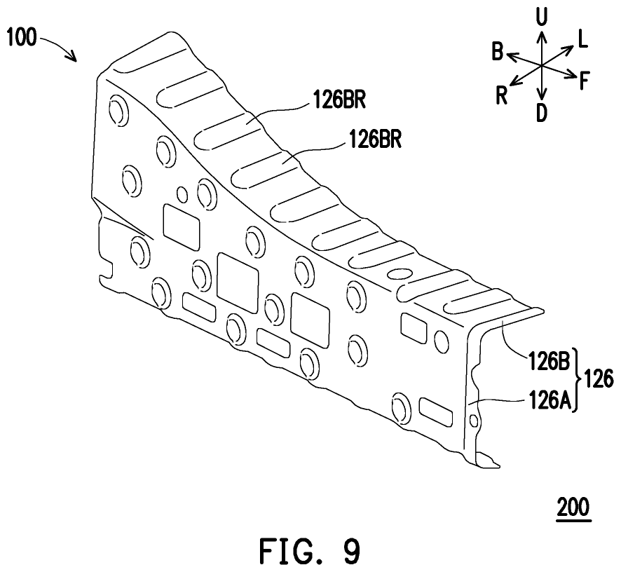

FIG. 8 is a schematic diagram of a vehicle body rear structure disposed in a vehicle according to another embodiment of the disclosure. FIG. 9 is a schematic view of the extension member of the vehicle body rear structure of FIG. 8. Please refer to FIGS. 8 and 9 at the same time. The extension member 126 includes: an inner wall 126A, which is located on the inner side in the width direction L-R of the vehicle 200; and an upper wall 126B, which extends from an upper portion of the inner wall 126A toward the outer side in the width direction L-R of the vehicle 200. The upper wall 126B has multiple bead portions 126BR (as shown in FIG. 9), and the length direction of the bead portion 126BR is the width direction L-R of the vehicle 200. The rear side frame lower 134 and the rear side frame upper 132 are connected to the bead portions 126BR (as shown in FIG. 8).

In this way, by connecting the rear side frame lower 134 and the rear side frame upper 132 to the bead portions 126BR, the load may be transmitted to the bead portions 126BR of high rigidity, thereby improving the joint rigidity. Therefore, even without adding reinforcing members such as cross members in the vicinity of the first joint portion 122 and the second joint portion 124 of the side sill 120 and the rear side frame 130, breakage that occurs when a collision load is applied in the front-rear direction F-B of the vehicle 200 can be suppressed. In addition, the upper wall 126B of the extension member 126 may withstand a load from the side (that is, in the width direction L-R of the vehicle 200) because of having the bead portions 126BR.

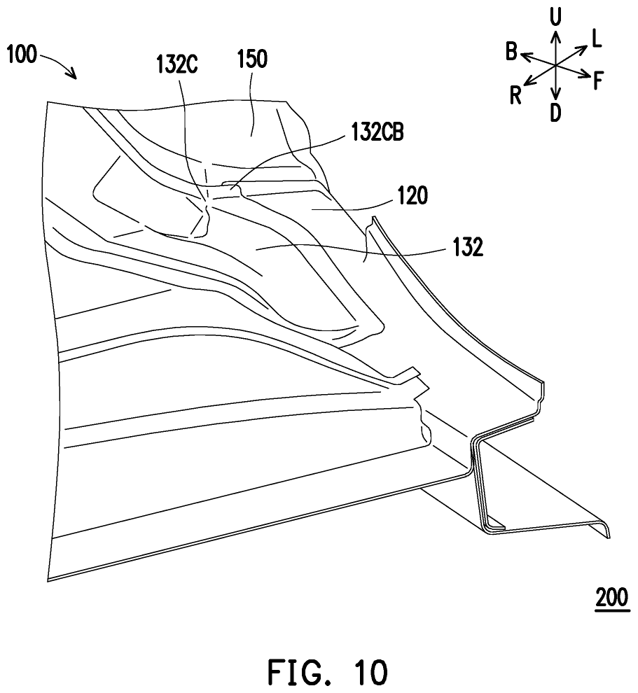

FIG. 10 is a schematic diagram of the vehicle body rear structure of FIG. 8 viewed from another angle. Please refer to FIGS. 8 and 10 at the same time. The vehicle body rear structure 100 further includes a wheel house 150, which is disposed above U the rear side frame upper 132. The rear side frame upper 132 includes a longitudinal flange 132C, which is disposed to the rear B of the second joint portion 124 and extends toward above U the vehicle 200. The longitudinal flange 132C has a third joint portion 132CB, and is connected to the wheel house 150 and the side sill 120 along the front-rear direction F-B of the vehicle 200.

In this way, by connecting the longitudinal flange 132C of the rear side frame upper 132 to the wheel house 150 and the side sill 120 in the front-rear direction F-B of the vehicle 200, the load input in the front-rear direction F-B of the vehicle 200 may be effectively transmitted, thereby improving the joint rigidity. Therefore, even without adding reinforcing members such as cross members in the vicinity of the first joint portion 122 and the second joint portion 124 of the side sill 120 and the rear side frame 130, breakage that occurs when a collision load is applied in the front-rear direction F-B of the vehicle 200 can be suppressed.

Referring to FIG. 4 again, the rear side frame upper 132 and the rear side frame lower 134 are joined together with the floor panel 110 sandwiched therebetween in the width direction L-R of the vehicle 200.

In this way, by joining the rear side frame upper 132 and the rear side frame lower 134 with the floor panel 110 sandwiched therebetween on the inner side in the width direction L-R of the vehicle 200, the rigidity of the rear side frame 130 may be improved, thereby improving the joint rigidity. Therefore, even without adding reinforcing members such as cross members in the vicinity of the first joint portion 122 and the second joint portion 124 of the side sill 120 and the rear side frame 130, breakage that occurs when a collision load is applied in the front-rear direction F-B of the vehicle 200 can be suppressed.

Referring to FIG. 7 again, the rear side frame 130 and the floor cross member 140 are spaced apart in the front-rear direction F-B of the vehicle 200. That is, in the front-rear direction F-B of the vehicle 200, the rear side frame 130 and the floor cross member 140 are spaced apart by a distance DL.

In this way, by spacing the rear side frame 130 and the floor cross member 140 in the front-rear direction F-B of the vehicle 200, the degree of layout freedom in the vicinity of the rear side frame 130 and the side sill 120 may be increased, and such a design may be applied to vehicle types with the rear side frame 130 of different overall lengths (In conventional technology, the rear side frame is connected to the floor cross member to bear the load in the front-rear direction of the vehicle. In this case, the length of the rear side frame and the connection to the floor cross member have to be specially designed and cannot be applied).

Based on the above, the vehicle body rear structure of the disclosure has at least the following technical effects.

By forming two rows of the joint portions between the side sill and the rear side frame lower/the rear side frame upper, the load between the side sill and the rear side frame can be dispersed by the two rows of the joint portions, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By joining the U-shaped rear side frame lower along the inner end portion of the side sill, the load in the front-rear direction of the vehicle may be effectively transmitted to the side sill, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

The rear side frame upper and the second joint portion of the side sill are disposed on the outer side of the first joint portion, and the joint portions (that is, the first joint portion and the second joint portion) are arranged in two rows. The load between the side sill and the rear side frame may be dispersed by the two rows of the joint portions, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By joining the rear side frame lower and the rear side frame upper to the extension member, the load between the side sill and the rear side frame may be dispersed by two rows of the joint portions (that is, the first joint portion and the second joint portion), thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By extending the extension member from the rear side frame to the floor cross member, the load input to the rear side frame may be transmitted to the floor cross member via the extension member, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By connecting the rear side frame lower and the rear side frame upper to the bead portions, the load may be transmitted to the bead portions of high rigidity, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed. In addition, the upper wall of the extension member may withstand a load from the side (that is, in the width direction of the vehicle) because of having the bead portions.

By connecting the longitudinal flange of the rear side frame upper to the wheel house and the side sill in the front-rear direction of the vehicle, the load input in the front-rear direction of the vehicle may be effectively transmitted, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By joining the rear side frame upper and the rear side frame lower with the floor panel sandwiched therebetween on the inner side in the width direction of the vehicle, the rigidity of the rear side frame may be improved, thereby improving the joint rigidity. Therefore, even without adding reinforcing members such as cross members in the vicinity of the first joint portion and the second joint portion of the side sill and the rear side frame, breakage that occurs when a collision load is applied in the front-rear direction of the vehicle can be suppressed.

By spacing the rear side frame and the floor cross member in the front-rear direction of the vehicle, the degree of layout freedom in the vicinity of the rear side frame and the side sill may be increased, and such a design may be applied to vehicle types with the rear side frame of different overall lengths (In conventional technology, the rear side frame is connected to the floor cross member to bear the load in the front-rear direction of the vehicle. In this case, the length of the rear side frame and the connection to the floor cross member have to be specially designed and cannot be applied).

Finally, it should be noted that the above embodiments are only used to illustrate the technical solutions of the disclosure, but not to limit the technical solutions of the disclosure. Although the disclosure has been described in detail with reference to the foregoing embodiments, those of ordinary skill in the art should understand that the technical solutions described in the foregoing embodiments may still be modified, or some or all of the technical features thereof may be equivalently replaced. However, these modifications or substitutions do not make the essence of the corresponding technical solutions deviate from the scope of the technical solutions of the embodiments of the disclosure.

What is claimed is:

1. A vehicle body rear structure, disposed in a vehicle, the vehicle body rear structure comprising:
a floor panel;
a side sill, disposed on an outer side of the floor panel in a width direction of the vehicle and extending along a front-rear direction of the vehicle; and
a rear side frame, connected to a rear portion of the side sill and extending along the front-rear direction of the vehicle at a rear portion of the vehicle,
wherein the rear side frame comprises a rear side frame upper located above the vehicle and a rear side frame lower located below the vehicle,
the side sill comprises a first joint portion, which is connected to the rear side frame lower, and a second joint portion, which is connected to the rear side frame upper, and
the first joint portion and the second joint portion are juxtaposed in the width direction of the vehicle and extend in the front-rear direction of the vehicle.

2. The vehicle body rear structure according to claim 1, wherein
the rear side frame lower comprises a side wall which opens upward and a bottom wall connected to the side wall,
the first joint portion is disposed along an inner end portion of the side sill in the width direction of the vehicle, and a joint flange of the side wall is joined to the side sill.

3. The vehicle body rear structure according to claim 1, wherein
the rear side frame upper extends from the rear side frame lower toward an outer side in the width direction of the vehicle, and
the second joint portion is disposed on an outer side of the first joint portion in the width direction of the vehicle.

4. The vehicle body rear structure according to claim 3, wherein
the side sill comprises an extension member, which extends along the front-rear direction of the vehicle within a cross section of the side sill, and
the rear side frame lower and the rear side frame upper are connected to the extension member.

5. The vehicle body rear structure according to claim 4, further comprising:
a floor cross member, disposed in front of the rear side frame and connected to the side sill, wherein
the side sill comprises an inner side sill, which is disposed on an inner side of the side sill in the width direction of the vehicle,
the extension member is disposed on the inner side sill, and
the extension member extends from the rear side frame to the floor cross member.

6. The vehicle body rear structure according to claim 5, wherein
the extension member comprises
an inner wall, which is located on an inner side in the width direction of the vehicle, and
an upper wall, which extends from an upper portion of the inner wall toward the outer side in the width direction of the vehicle,
wherein the upper wall has a plurality of bead portions, and a length direction of the bead portion is the width direction of the vehicle, and
the rear side frame lower and the rear side frame upper are connected to the bead portions.

7. The vehicle body rear structure according to claim 4, further comprising:
a wheel house, disposed above the rear side frame upper,
wherein the rear side frame upper comprises a longitudinal flange, which is disposed behind the second joint portion and extends toward above the vehicle, and
the longitudinal flange has a third joint portion, which is connected to the wheel house and the side sill along the front-rear direction of the vehicle.

8. The vehicle body rear structure according to claim 1, wherein
the rear side frame upper and the rear side frame lower are joined together with the floor panel sandwiched therebetween on an inner side in the width direction of the vehicle.

9. The vehicle body rear structure according to claim 5, wherein
the rear side frame and the floor cross member are spaced apart in the front-rear direction of the vehicle.
